(19) United States
(12) Patent Application Publication
(10) Pub. No.: US 2010/0288569 A1
(43) Pub. Date: Nov. 18, 2010

(54) Carbon fiber composite body, multi-fuel engine charging system, electrically driven car

(76) Inventor: Ronald Craig Fish, Los Gatos, CA (US)

Correspondence Address: RONALD CRAIG FISH, A LAW CORPORATION, PO BOX 820, LOS GATOS, CA, 95032, US

(21) Appl. No.: 12/454,346

(22) Filed: May 15, 2009

(51) Int. Cl. B60W 10/26; B60W 20/00

(52) U.S. Cl. 180/65.29; 180/65.21

(57) ABSTRACT

A very light, very small (½ lane width) carbon fiber composite hull, single passenger (or two passenger in tandem F18 cockpit style) Formula-One-form-factor, flex-fuel, plug-in hybrid with swappable battery packs. The battery pack not being used will be charged by a home charging station that uses solar panels during the day and a computer to control the charge and which completes the charge from the grid at night or at low demand times to even out the load on the grid. The flex fuel engine may only drive a generator like in the case of the Chevy Volt and will run on ethanol, compressed natural gas or gasoline. The car will have very low drag as the Formula One front and rear aerodynamic wings will be extended to cover the open wheels to reduce vortices. These wings will also be covered with solar panels to provide partial trickle charge while the car is in the sun while parked at work etc.

### BACKGROUND

President Obama's emphasis on green technology as a means to revive the economy and move toward energy independence is laudable, but to the extent it is focused on wind and solar technologies to generate electricity and upon weatherization of houses, it somewhat misses the mark. Fifty percent of our electricity is generated from coal and that mostly comes from the US. Very little of our electricity is generated by oil fired plants.

Seventy percent of the oil we consume (most of which is imported) goes for transport via cars, trucks and planes. Expanding wind and solar and other electricity generating technologies won't immediately ease our dependence upon foreign oil until the transportation fleet becomes electric powered.

There is a great deal of waste now in our fuel consumption. Most cars are four or more passenger vehicles and 99% of the drivers driving them are alone at least during commute time. That means a great deal of extra weight is being moved around by fossil fuel engines. Each acceleration of that extra weight wastes energy and each time all that extra weight is stopped by conventional brakes, more energy is wasted.

The problem with existing EV/plug-in hybrid technologies is they do not address the issue of increased demand for recharging power that will be placed on the electric power generation and transmission grid, and they do not address the problem of increasing traffic congestion as the population grows. Nor do they address the problem of what happens when gasoline becomes very scarce or non existent. A single passenger, electrically powered with a backup flex fuel engine to give the car infinite range is needed.

### BRIEF DESCRIPTION OF THE DRAWINGS

FIG. 1 is a front view of one embodiment of a Formula One form factor plug-in hybrid with a flex fuel engine for driving a generator to drive the electric motor based drive train and charge the batteries.

FIG. 2 is a diagram of the preferred charging system for the modular battery not in use in the vehicle.

FIG. 3 is a side view of one embodiment of a Formula One form factor plug-in hybrid with a flex fuel engine for driving a generator to drive the electric motor based drive train and charge the batteries.

FIG. 4 is a diagram of one embodiment for a charging/swapping mechanism to charge the alternative Lithium-Ion battery pack and swap it for a depleted or run down battery pack 22 in the car.

### DETAILED DESCRIPTION OF THE PREFERRED EMBODIMENT

The preferred embodiment contemplates a single or two passenger (F18 tandem cockpit style) carbon fiber composite body plug-in hybrid for commuters which has a flex-fuel backup fossil fuel engine to drive a generator that can drive the electric motor and charge the batteries when they are in need of charge. The electric drive train will have a swappable Lithium-Ion battery pack that weighs about half that of current plug-in hybrids. The car will only be half the size of the typical hybrid being only half the width of a traffic lane and about half the length of a Formula One car. The car, in the preferred embodiment, is a single passenger or two passenger tandem (F18 style) cockpit in a Formula One form factor. It is projected to have a range of at least 80 miles on one charge and a top speed of 85 MPH with “gas” mileage which is expected to be over 100 MPG depending upon the commute distance traveled. If the commute distance traveled is less than the 80 mile range, the flex fuel engine will never have to run and the vehicle with have extremely high gas mileage.

The swappable battery packs allow one battery pack to be charged by a solar and/or wind powered charger during the day with a computer controller controlling the charge and finishing the charge from the power grid at night if necessary.

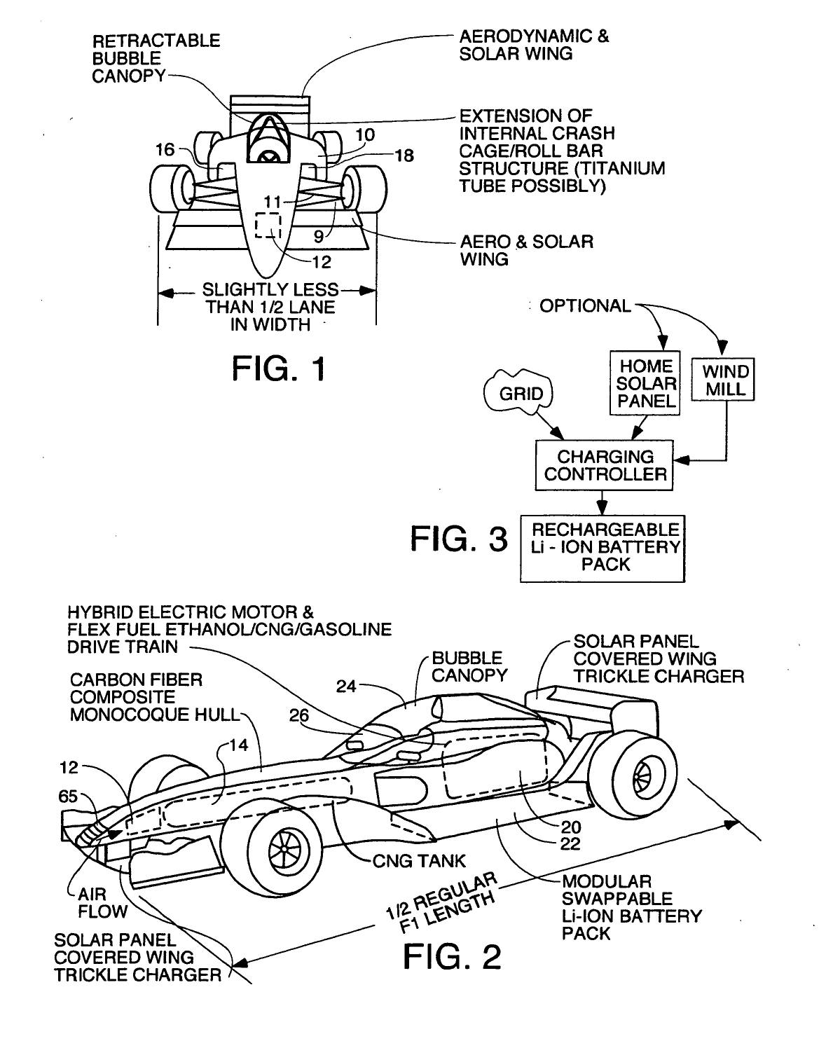

FIGS. 1 and 3 show a prototype of a electrically driven plug-in hybrid for commuters which has a multi-fuel backup engine 12 (1.4 Liter, 4-cylinder Chevy Volt engine adapted to CNG, ethanol and ethanol blends as well as gasoline is preferred) to drive a generator that can drive the electric motor and charge the batteries when they are in need of charge. In another embodiment, the engine 12 is a 1 liter displacement engine or smaller which has been modified to run on CNG and/or ethanol or ethanol blends in addition to gasoline. All embodiments have to have a multi-fuel engine which can run on CNG in addition to one other fuel, preferably gasoline. Such modifications include a pressure regulator (not shown) for the CNG fuel to step it down in pressure from storage pressure to a pressure at which it can be mixed with air for injection into the cylinders. Electronic advancement or retardation of spark timing may also be used in some embodiments with the timing unit connected to a switch in the cockpit (not shown) which controls valves in a plumbing system (not shown) to guide the selected fuel to the engine 12. The car of FIGS. 1 and 3 has a carbon fiber composite body 10 with a multi-fuel engine 12 that runs on one fuel at a time which the driver selects.

The multi-fuel engine can be any of the multi-fuel engines currently available such as the Fiat Siena Tetrafuel engine which is commercially available in the Brazilian market. This engine is a 1.4 L FIRE motor that runs on E100 (pure ethanol), E25 (standard Brazilian gasoline which has a percentage of ethanol in it), gasoline and compressed natural gas (CNG). The driver chooses the fuel the engine runs on using a switch in the cockpit. Peugot, Honda, Toyota and Volkswagen also make bi-fuel engines that run on CNG and other fossil fuels like gasoline. It is not necessary that the engine 12 run on more than two fuels. Any flex fuel engine that can burn both CNG and gasoline or CNG and ethanol or ethanol mixtures will suffice for engine 12. In the preferred embodiment, the multi-fuel engine will run on CNG, gasoline, ethanol mixtures or diesel fuel manufactured from coal via a process identical to or similar to the process invented by Sasol of South Africa. America is the Saudi Arabia of coal, and when gasoline becomes scarce, this coal-to-liquid fuel could be manufactured in abundance.

A CNG tank 14 is welded or otherwise affixed such as by bolting flanges on the sides of the tank to an internal safety cage/chassis (not separately shown) which serves both as a crash cage and as the chassis of the car. In one embodiment, the CNG tank is located in the nose of the car as is the multi-fuel engine 12, but in other embodiments, they could be located in the rear of the car or anywhere else since their position need not be related to the position of any of the wheels of the car.

It is this chassis to which the suspension and running gear, transmission, electric motor 20 and modular Lithium-Ion battery pack 22 are mounted. Putting the CNG tank 14 in front of the car and making it part of the chassis makes the car lighter since the tank is strong and can supplant part of the chassis material. Other tanks 61 for storage of ethanol and gasoline (or just gasoline or just ethanol or ethanol blends in some embodiments) combined into one tank in some embodiments) are located at 16 and 18 in FIG. 1 for some embodiments or in the rear of the car at 61 in other embodiments. The tanks at 16 and 18 are located where the air intakes for cooling the Formula One engine used to be in the embodiment of FIG. 1. These air intakes are no longer needed since the car is electrically driven by an electric motor 20 and transmission located where the Formula One gas engine used to be behind the cockpit. In the preferred embodiment, the electric motor is a 160 horsepower motor, but larger or smaller horsepower electric motors can also be used in other embodiments.

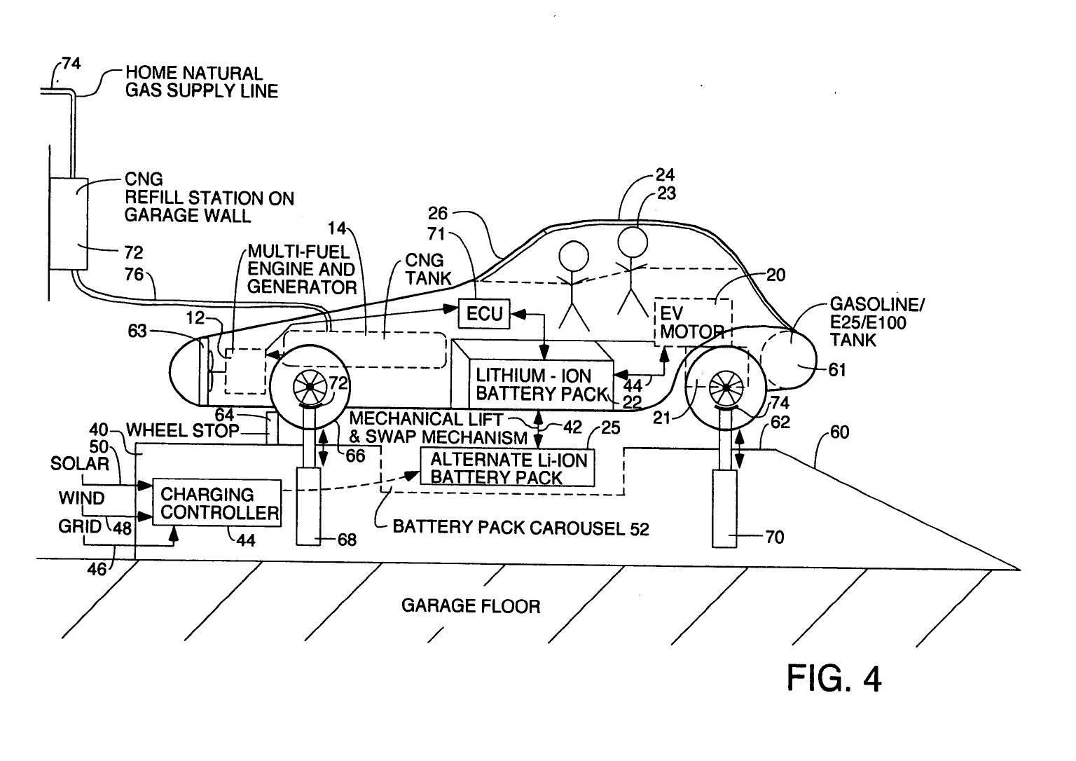

In some embodiments, tanks 16 and 18 may be mounted above the battery pack bay that receives the rechargeable battery pack and which extends across the width of the car under the passenger compartment in the embodiment shown in FIGS. 1 and 3. In other embodiments, the battery pack bay may be in the nose of the car and the multi-fuel engine 12 and the CNG storage tank located under the passenger compartment or in one of the side compartments beside and below the cockpit that hold tanks 16 and 18. In such an embodiment, at least one of the Formula One air intakes still exists to cool the multi-fuel engine and the electric motor 20. In fact, in the preferred embodiment shown in FIGS. 1 and 3, at least one of the original Formula One air intakes is preserved to cool the electric motor 20, but it may be substantially smaller than in an actual Formula One car since not as much horsepower and heat is being generated in the car of FIGS. 1 and 3. A separate air intake in the nose of the car guides air to a radiator that cools multi-fuel engine 12. In some embodiments, the multi-fuel engine is air cooled to save the weight of the radiator and cooling liquid since it often will not run at all on trips within the range of the battery pack. A radiator and fan cooling structure is shown at 63 in the embodiment of FIG. 4, and FIG. 3 illustrates an air cooled embodiment where an air intake grill 65 lets air flow back into the nose to cool the multi-fuel engine 12.

The flex fuel engine 12 drives a generator (not separately shown but part of engine 12 in FIGS. 1 and 3) with sufficient output power to drive the electric motor 20 and charge the swappable battery pack 22. Such a generator is known and is used in the Chevy Volt prototype. The generator of the Chevy Volt outputs 53 kilowatts and is driven by a four cylinder engine. Since the car of FIGS. 1 and 3 will be substantially lighter than the Chevy Volt, the generator driven by multi-fuel engine 12 may have less output and the engine 12 can be smaller and lighter. The Chevy Volt only has a range of 40 miles so some embodiments will use a 53 kilowatt generator and a battery pack that is about the same size as the Chevy Volt battery pack with a car that only weighs about half as much so as to extend the range on battery power only by a substantial margin over the 40 mile range of the Chevy Volt. Other larger or smaller capacity generators may be used in other embodiments to deliver different performance levels. An electronic control unit 71 shown in FIG. 4 controls whether the output of the generator is supplied to the electric motor 20 or the batteries or both depending upon the state of charge of the batteries. A single tank of fuel can extend the range up to in excess of 600 miles in some embodiments with re-fueling enabling unlimited range.

Regenerative braking like in conventional hybrids like the Toyota Prius is used so that when the car is being braked, the electric motor is turned into a generator to supply charging current to the swappable battery pack 22 to provide a partial recharge. The battery pack 22 may be a 16 kWh battery pack like is used in the Chevy Volt or it may have more or less capacity. Such batteries are commercially available from Compact Power Incorporated of Detroit, Mich., a subsidiary of a Korean company, LG Chem. In some embodiments using the same battery pack as the Chevy Volt, the battery pack weighs 375 lbs. But in other embodiments, a battery pack weighing half that much can be used. The battery pack 22 needs a minimum temperature of between 32° F. to 50° F. (0° C. to 10° C.) to be used and when the car disclosed herein is plugged in, the battery will be kept warm enough so that it can be used immediately when the car is unplugged. If the car is kept unplugged and the temperature of the battery is below the minimum temperature, the multi-fuel engine will run until the battery warms up. This temperature regulation is done since electro-chemical batteries have degraded performance when they are very cold

The electric motor drive train 20 can be any commercially available electric motor drive train like the one in the Tesla electric cars or the Voltec drive train which is soon to be commercially available in the Chevy Volt. Infinitely variable ratio transmissions are generally used, but any type of transmission 21 suitable for the weight of the car and the torque of the electric motor 20 may be used. The horsepower of the electric motor can be less than used in the Tesla or the Chevy Volt since the car will weigh substantially less than either of these prior art vehicles.

Referring to FIG. 4, there is shown a diagram of one embodiment for a charging/swapping mechanism to charge the alternative Lithium-Ion battery pack and swap it for a depleted or run down battery pack 22 in the car. Power for the electric motor 20 will come from a swappable Lithium-Ion battery pack 22. This battery pack 22, when discharged or too low on charge for the desired driving range, is replaced with a charged up alternate battery pack 25 that is stored and charged in charging/swapping mechanism 40.

The swappable battery pack is lifted into the car by a mechanical lift and swap mechanism 42 which may be hydraulic jacks, electrically driven scissor mechanisms, jack screws, etc. Any kind of mechanism that can lift the weight of the battery pack into the car and out of the car will suffice. The alternate battery pack 25 is stored in a battery pack carousel or swapping mechanism that works linearly or rotates. There is one slot in the carousel or linearly operating swap mechanism for battery pack #1 which is in the car and one slot for alternative battery pack #2 which is charging while the car is being driven on battery pack #1. The carousel or linear swapping mechanism functions to move up and attach to battery pack #1 and lower it down into its charging slot, and then rotate or slide alternative battery pack #2 into place beneath the battery pack bay on the underside of the car. The carousel or linearly operating swapping mechanism then uses mechanical lift and swap mechanism 42 to lift battery pack #2 up into the battery pack bay until it latches and is mechanically secure. Typically the battery pack in the battery pack bay engages latches which latch the battery pack to the chassis (not shown). Electrical connection 44 between the battery pack in the battery pack bay and the electric motor drive train 20 is by surface contacts on the battery pack like are used for rechargeable battery packs some digital cameras or by a cable that the operator of the car plugs into a receptacle on the battery pack after it has been latched into the car.

The battery pack weighs about half (200 lbs typically) of the battery pack in a conventional full size hybrid. This is because the car will only be half the size of the typical hybrid being only half the width of a traffic lane and about half the length of a Formula One car and will be very light since the body 10 is made of carbon fiber composite. The Tesla roadster will even weigh more than the car shown in FIGS. 1 and 3 since the performance of the Tesla roadster in terms of acceleration and top speed is more than is needed for this commuter/errand running vehicle. This car will have very little if any storage space other than the back seat when no second passenger 23 is present. The car is not designed for long haul trips where luggage needs to be carried.

The car is a single passenger or two passenger tandem (F18 style) cockpit in a Formula One form factor. A bubble canopy 24 either slides back on rails or is lifted up from rear hinges like a jet fighter canopy with gas struts or hydraulic assistance in some embodiments. The canopy mates with a windscreen 26, and is removable in some embodiments. In other embodiments, a conventional four passenger hybrid form factor like the Prius or Honda Insight for 2009 is used for the body, but the propulsion, multi-fuel engine charging system and swappable, modular Li-Ion battery pack system of FIGS. 1 and 3 is still used.

The car is designed to have a range of at least 80 miles on one charge and a top speed of 85 MPH with “gas” mileage which is expected to be over 150 MPG depending upon the commute distance traveled. If the commute distance traveled is less than the 80 mile range, the flex fuel engine will never have to run and the vehicle with have extremely high gas mileage. The Chevy Volt, which is a much bigger and heavier car, gets 50 MPG if the battery is discharged and gets 150 MPG if the battery is re-charged every 60 miles. For the car disclosed herein, efficiency of greater than 150 MPG with no long down times for recharging (8 hours for the Chevy Volt batteries if 115 VAC is used, 3 hours for 240 VAC charging if the battery is fully depleted) if the battery pack is swapped every 60 miles or thereabouts depending upon size and capacity and the range of the battery pack versus the weight of the car.

A multi-fuel engine 12 will be used to drive a generator that both can run the electric motor and charge the batteries. The multi-fuel engine can run at constant speed for efficiency and mechanical simplicity. There is no need for any throttle linkage or electronic control system since the engine 12 is not connected to the wheels. Electronic mixture control and spark advance is used in some embodiments where necessary because of the fuels the driver can select. The ECU 71 will monitor the state of charge of the battery and maintain it within a range of charge, preferably between 30% and 80%. The ECU 71 in FIG. 4 will automatically start the multi-fuel engine 12 to start the charging process when the state of the charge falls to or below about 30%. Other ranges can be used in other embodiments depending upon the desired level of performance to be maintained for the vehicle. This range of charge was selected because it is the same range used in the Chevy Volt, but the car of FIGS. 1 and 3 is a much lighter car so acceptable performance levels may be obtained even when the battery charge is substantially below 30%.

In some embodiments, the flex fuel engine 12 will run on pure ethanol or some mixture of ethanol and gasoline, compressed natural gas or gasoline. Such an engine for some embodiments has already been designed and will be commercially available in a year or so in the Obvio, a flex fuel sports car to be exported by Brazil. Compressed natural gas proved to be the lowest cost per mile in a cross country race of green cars from Chicago to the west coast which I read about in Popular Mechanics a couple of years ago. The CNG car beat out all the other types of cars including a hydrogen powered car, a hybrid, a pure electric car, gas powered car and a diesel powered car in a cross-country race in terms of cost per mile. Refueling the flex fuel engine with CNG will be easy and can be done in the owner's garage. Honda Motors already has a pure CNG Civic and sells a wall unit that refuels the car from the natural gas pipelines in the homeowner's home.

The vehicle shown in FIGS. 1 and 3 will also be very light and fast since it will a monocoque hull made of carbon fiber composites which are very light, stiff and stronger than steel. Kitplane construction techniques can be used to layout the hull from foam molds cut with hot wire. The car could even be sold as a kit using kitplane technology to keep its cost down to an affordable level for most homeowners. Electric cars today are all very expensive. Only recently has one been announced under $50,000. This is out of reach for most homeowners especially for a single or two passenger car. One of the biggest issues will be making the car simply and cheaply and making it safe. I will have my team approach this using kitplane construction techniques to build a carbon fiber hull on a steel tube safety cage/chassis.

Electric motors have excellent torque at all RPM levels so the car will accelerate very fast and reach cruise speed quickly.

Reliability and unlimited range will be provided by the flex fuel backup engine. Convenience will be provided by the home charging station which provides the ability to recharge the vehicle with CNG when it is parked overnight in the owner's garage. Additional convenience will be provided by enabling the car's backup flex fuel engine to run on gasoline or ethanol. Good gas mileage will be provided by the electric drive train and the long range provided by the lightness and smallness of the car.

Negative impact on the grid from overloading if many of these cars and other plug in hybrids are sold will be avoided by using swappable battery packs, and a solar/wind/grid charger for the battery pack not in use. In FIG. 4, a charging controller 44 has inputs for charging power from the grid 46, from an optional wind turbine 48 or from an optional solar panel array 50. The battery pack #2 which not in use can be charged in its slot in the battery pack carousel or linear operating swapping mechanism 52 by a solar charger and/or wind turbine during the day and the charge will be monitored by a computerized controller 44 so as to be completed at night or at low demand times by taking in power from the grid 46 when demand for power is lower. FIG. 2 illustrates this charging system schematically, and the same charging system is also shown as integrated into the charging/swapping mechanism 40. This type charging system will help alleviate the problem of the need to build expensive new power generation plants and politically dicey transmission lines as the fleet is electrified and demand for recharging power rises.

The charging/swapping system 40 can sit on the floor in a user's garage or can be in a charging/swapping station deployed at a company or throughout a city. User's can pay a fee for every swap. The particular design shown in FIG. 4 uses a ramped platform with a ramp 60 that the driver drives up to put the car on a flat platform surface 62. The platform surface has tracks to guide the car and front wheel stops 64 which stop the front wheels 66 of the car when the battery pack bay is positioned correctly over a battery swap bay. Once the car is in the correct position, hydraulic cylinders 68 and 70 move jacking surfaces 72 and 74 into position to engage the chassis of the car and lift it up. This structure is optional and may not be used in embodiments where the battery swapping carousel or linearly operated mechanism can operate with just the clearance between the bottom of the car and the top of the carousel. In fact, in the preferred embodiment, there are no jacking mechanisms to jack the car. The car is just driven up into position, the carousel or linearly operated swapping mechanism moves an empty slot into the position to receive the battery pack out of the car and then the swapping mechanism 42 moves up and mechanically engages the spent battery pack and unlatches the latch mechanism and lowers it into the empty slot. The freshly charged battery pack 25 is then rotated or slid into place and the battery swapping mechanism lifts it up into the battery pack bay on the underside of the car and latches it in place.

The design of a solar/wind powered charging system backed up by the grid that has hydraulics or mechanical mechanism to handle the heavy battery packs (estimated at 200 lbs) to take a discharged battery pack out, connect it to the charger and put a charged pack back in can take many forms. The form shown in FIG. 4 is only one example. This particular embodiment shown in FIG. 4 uses a carousel or linearly operated swapping mechanism with hydraulics, scissor or jack screw mechanisms to lift the discharged pack out and put the charged battery pack back in. Solar powered hybrid battery charging systems are already in use at Google, so the technical problems of solar charging battery packs with this much size and power have already been solved. So the main problem is the modular battery pack design and the mechanical design of a battery pack handler.

The CNG storage tank 14 can be charged overnight by a wall charger 72 which is connected to the home natural gas supply 74. A pressure hose 76 takes pressurized natural gas and guides it into the tank 14. Such wall chargers are already designed and commercially available when a natural gas powered Honda Civic is purchased.

Safety issues will be handled by using a steel or titanium tube chassis roll cage inside the hull and a four point restraint seat belt if the carbon fiber composite hull alone is insufficient to provide crash protection. A helmet-based NASCAR head movement restraint that activates in a crash to prevent whiplash injuries and includes the car's radio and Bose noise cancelling headsets is used in some embodiments. Airbags will not be necessary with such a design, and this should make the car cheaper to build.

Two of these cars will be able to fit side by side in one lane, and drag, which is proportional to the wetted fuselage area will be reduced by making the car about half the length of a Formula One car. The aerodynamic wings of the F1 hull will be extended (not shown) on the front and back to cover the open wheels and the strut/steering and shock absorbing mechanisms 9 and 11 in FIG. 1 to reduce vortices and resulting increased drag.

This car is distinguishable from all other plug in hybrids of which I am aware because of the flex fuel backup engine, the carbon fiber composite hull and the half lane width of the car.

Impact on Energy Independence

Substantial savings in consumption of oil for transportation are expected if many of these cars are sold.

Impact on Jobs

Millions of jobs will be created in manufacturing of the cars, parts for it, solar panel manufacture and installation, CNG charging stations, battery handling equipment, computer controllers, kit construction by contractors, etc. Factory versions of the car will be built by displaced auto company workers in the US. Design may be in Michigan or by telecommuters from Michigan or Japan depending upon who partners with me. Demand for grid power will also create millions of jobs in the utilities and in construction trades to build new solar, hydro, wind, gas-fired or nuclear power plants and transmission lines. I justify my assertion that millions of jobs will be created by the fact that millions of jobs have existed for decades stemming from the SUVs and trucks Detroit is currently selling (well, actually, not selling right now) These jobs exist in many sectors of the economy in building, selling, servicing, fueling, selling repair parts and modification parts, painting and customizing. It has been said that ⅓ of the jobs in America depend directly or indirectly on the auto industry. The fleet needs to be replaced with higher efficiency cars if we are to survive as a nation and a world. We only have about 38 years of oil left, not counting the continued growth of China and India. We actually only have about 28 years left before major disruptions of the world's markets occur resulting from energy shortages (James Kunstler, “The Long Emergency” 2005 Grove Press, NY, ISBN 0-0821-4249-4)

Impact on Traffic Congestion and the Existing Highway Infrastructure

Substantial easing of traffic congestion is expected by doubling each lane's capacity.

Impact on the Environment

Substantial improvements in greenhouse gas emissions expected especially if solar recharge works well

2. The apparatus of claim 1 further comprising:
wherein said chassis and body are sized such that the distance from the outside of the wheels on one side of the vehicle to the outside of the wheels on the other side of the vehicle is approximately half the width of a traffic lane, said body having two seats mounted one behind the other.

3. The apparatus of claim 1 further comprising:
an electric motor coupled to drive at least one wheel and coupled to receive power from any modular rechargeable battery pack fastened into said bay via a cable or any other electrical path that couples power from a battery module fastened into said bay and said electric motor; and
an engine coupled to a generator to generate power to drive said electric motor when said modular rechargeable battery pack needs recharging.

4. The apparatus of claim 2 further comprising:
an electric motor coupled to drive at least one wheel and coupled to receive power from any modular rechargeable battery pack fastened into said bay via a cable or any other electrical path that couples power from a battery module fastened into said bay and said electric motor; and
an engine coupled to a generator to generate power to drive said electric motor when said modular rechargeable battery pack needs recharging.

5. The apparatus of claim 3 wherein said engine is a multi-fuel engine being capable of running at least on compressed natural gas and at least one other fuel selected from the group: gasoline, ethanol, ethanol and gasoline blends, and/or liquid fuel generated from coal.

6. The apparatus of claim 2 wherein said engine is a multi-fuel engine being capable of running at least on compressed natural gas and at least one other fuel selected from the group: gasoline, ethanol, ethanol and gasoline blends, and/or liquid fuel generated from coal.

7. The apparatus of claim 3 further comprising a charging control system or ECU coupling said generator to said rechargeable battery pack and to said electric motor to control the charge of said battery pack or to supply power to said electric motor or both.

8. The apparatus of claim 2 further comprising a charging control system or ECU coupling said generator to said rechargeable battery pack and to said electric motor to control the charge of said battery pack or to supply power to said electric motor or both.

9. The apparatus of claim 3 further comprising a charging control system coupling said generator to said rechargeable battery pack to control the engine to maintain the charge of said modular rechargeable battery pack within predetermined levels.

10. The apparatus of claim 2 wherein said body is made of carbon fiber composite material.

11. The apparatus of claim 1 wherein said chassis and body have a shape and size sufficient to have a front and back seat sufficient to accommodate at least four passengers, and wherein said body is made of the same type materials used in the Toyota Prius® or Honda Insight® hybrid cars.

12. An electrically driven vehicle having a modular, replaceable, rechargeable battery pack which can be attached to the vehicle by latches or any other fastening mechanism which are such that said battery pack can be quickly removed and replaced with another battery pack.

13. A vehicle having a body coupled to a chassis and wheels coupled to said chassis by a suspension system such that a propulsion mechanism comprising at least an electric motor and modular, easily removable rechargeable battery pack which latches into a bay in said chassis and an engine which can generate electric power to drive said electric motor or charge said rechargeable battery pack or both, said body having two seats therein arranged such that one seat is behind the other, said chassis and body having a width which is approximately one half or less of the width of a standard traffic lane.

14. The vehicle of claim 13 wherein said engine is a flex fuel engine which works together with said electric motor and said rechargeable battery pack to drive said wheels such that said electric motor drives said wheels while said rechargeable battery has sufficient power stored therein to drive said electric motor and said flex fuel engine drives said wheels by generating power to drive said electric motor when said rechargeable battery does not have sufficient power to meet demand by a driver of said vehicle.

15. The vehicle of claim 14 wherein said body is made of carbon fiber composite material.

16. A battery charging/swapping station comprising:
a mechanical carousel or sliding mechanism that functions to:
reach up, unfasten and remove a first modular rechargeable battery pack that is removeably mounted in a bay on the underside of an electrically powered vehicle chassis;
rotate or slide so as to move said first rechargeable battery pack out from under said bay and move another second rechargeable battery pack into position under said bay;
lift up said second rechargeable battery pack and attach it into place in said bay; and
control recharging of said first rechargeable battery pack so as to recharge it.

17. The battery charging/swapping station of claim 16 having a charging system which functions to control charging of said first rechargeable battery pack so as to charge said battery pack first from one or more alternative energy sources selected from the group comprising: solar power, wind power, geothermal power, tidal power or any other alternative energy source which is available, and second from a power grid powered by power plants fired by nuclear power, coal, natural gas, oil or other fossil fuel sources.

18. The battery charging/swapping station of claim 16 wherein said charging system controls recharging of said first rechargeable battery pack so as to use any available alternative energy source to charge said first rechargeable battery pack during daytime and, if necessary, finishes charging said first rechargeable battery pack from said power grid at night or during other low demand times on said grid.
